(19) United States
(12) Patent Application Publication
(10) Pub. No.: US 2024/0170982 A1
(43) Pub. Date: May 23, 2024

(54) ELECTRIC VEHICLE CHARGER WITH DOUBLE-DOOR BOX SEPARATING HIGH AND LOW VOLTAGE PARTS FROM EACH OTHER

(71) Applicant: Hyundai Kefico Corporation, Gunpo (KR)

(72) Inventor: Jun Ho Lee, Seoul (KR)

(21) Appl. No.: 18/389,484

(22) Filed: Nov. 14, 2023

(30) Foreign Application Priority Data
Nov. 21, 2022 (KR) 10-2022-0155979

(51) Int. Cl. H02J 7/00; B60L 53/18; B60L 53/302

(52) U.S. Cl. CPC H02J 7/0042; B60L 53/18; B60L 53/302

(57) ABSTRACT

Provided is an electric vehicle charger with a double-door box separating high and low voltage parts from each other, which is capable of minimizing electromagnetic interference by separating high and low voltage parts from each other by a double-door disposed in the front side of the charger and of improving efficiency of maintenance by allowing easy access from the front side toward the internal space of the charger. The electric vehicle charger may include an outer box main body, a front door mounted to be openable and closable at the front side of the outer box main body, a double-door box mounted to be openable and closable inside the front door and including the low voltage part arranged thereon, and the high voltage part arranged on an inner rear surface of the outer box main body and separated from the low voltage part by the double-door box.

### CROSS REFERENCE TO RELATED APPLICATION

The present application claims under 35 U.S.C. § 119(a) the benefit of Korean Patent Application No. 10-2022-0155979, filed Nov. 21, 2022, the entire contents of which are incorporated herein for all purposes by this reference.

### BACKGROUND

### Technical Field

The present disclosure relates to an electric vehicle charger with a double-door box separating high and low voltage parts from each other. More particularly, the present disclosure relates to an electric vehicle charger with a double-door box separating high and low voltage parts from each other, the charger being capable of minimizing interference of electronic waves by separating a high voltage part and a low voltage part from each other through a double-door disposed at the front side thereof and being capable of improving efficiency of maintenance by allowing easy access from the front side of an outer box main body toward the inside space of a charger main body.

### Background

Existing vehicles that use gasoline, diesel, kerosene, gas, etc. cause problems such as air pollution, global warming, and energy resource depletion. Recently, electric vehicles developed in order to solve these problems have been making progress in a form combined with IT technology. A high-speed charger for electric vehicles, which rapidly charges a battery of an electric vehicle, is one of key devices required for driving an electric vehicle.

High-speed charging methods of electric vehicles are divided into the CHAdeMO method and the Combo method that use direct current, and the 3-phase (AC3P) method that uses alternating current. Conventionally, due to the lack of international standards, electric vehicle high-speed chargers using different charging methods were developed by each manufacturer, but recently, electric vehicle high-speed chargers integrating the above-described 3 methods have appeared.

Korean Patent No. 10-1506015 proposed a charger for electric vehicles that can be commonly used for various electric vehicles produced by various automobile companies. According to the charger, a control circuit is installed inside a charger main body, and the control circuit includes a switching device that selects DC power and AC power for DC high-speed charging and AC high-speed charging and a communication module that notifies a supplier of billing and power usage via wired or wireless means.

Inside the main body of the electric vehicle charger, a high voltage part supplying charging power and a low voltage part taking charge of control/communication are mixed in the same space without separate shielding, resulting in problems such as malfunctions such as poor communication and billing errors due to electromagnetic interference between the high voltage part and the low voltage part.

### SUMMARY

Accordingly, the present disclosure has been made keeping in mind the above problems occurring in the related art, and the present disclosure is intended to propose an electric vehicle charger with a double-door box separating high and low voltage parts from each other, the electric vehicle charger being configured to minimize electromagnetic interference by separating a high voltage part and a low voltage part of the electric vehicle charger by a double-door and to prevent malfunctions due to poor communication, billing errors, etc., and to improve efficiency of maintenance by allowing access from the front side of an outer box main body towards the internal space of a charger main body.

In order to achieve the above-described objective, according to an exemplary embodiment of the present disclosure, provided is an electric vehicle charger including: an outer box main body; a front door mounted to a front portion of the outer box main body and configured to be opened and closed; a double-door box mounted to an inner side portion of the outer box main body and configure to be opened and closed and including a low voltage part that is arranged thereon; and a high voltage part separated from the low voltage part by the double-door box.

The high voltage part may be arranged on a surface mounted to an inner side portion of the outer box main body.

The outer box main body may have a closure structure of which the front door is configured to be opened or closed and have a cooling part partitioning plate separating the high voltage part at an upper portion and a cooling part at a lower portion from each other and blocking a flow of heat.

The cooling part partitioning plate may have an inlet port that allows a cable to be inserted into the cooling part.

The cooling part partitioning plate may be horizontally arranged in the outer box main body.

The front door may be hinged to the front portion of the outer box main body.

The front door may include a connector assembly connected to a cable that includes an electric line and a communication line, a button controller electrically connected to a control circuit, and/or a reader recognizing credit card information, a payment bar code, or a QR code to pay charges.

The front door may include an opening and closing handle that is configured to open and close the front door.

The front door may include an emergency stop switch to stop operation of the electric vehicle charger when an emergency event occurs during charging.

The front door and the double-door box may be respectively mounted to opposite inner side portions of the outer box main body so that the front door and the double-door box may be configured to be opened and closed alternately.

The double-door box may include the low voltage part provided at a front surface thereof, the low voltage part taking charge of control/communication of the electric vehicle charger, and a first portion of the double-door box may be connected to the outer box main body by a hinge.

The double-door box may include a fixing member at a second portion, to which the hinge is connected, to allow the double-door box to be fixed to the outer box main body.

The double-door box may have a cable inlet port to allow a cable to be inserted.

The double-door box may be made of an electromagnetic shield material to prevent electromagnetic interference of the low voltage part and the high voltage part. The electromagnetic shield material may be made by adding copper ions to copper, aluminum, or acrylic fiber.

The low voltage part may include a charger controller, a DC power supply device, a low voltage cable duct, and/or a low voltage relay.

The high voltage part may serve to supply power for charging. The high voltage part may include a DC input cable, a DC output cable, a high voltage relay, and/or a high voltage bus bar.

As described above, according to the electric vehicle charger with a double-door box separating high and low voltage parts from each other according to the present disclosure, the double-door box with the low voltage part is installed at the front side of the outer box main body on which the front door is mounted, and the high voltage part is installed on an inner surface of the outer box main body behind the double-door box. Accordingly, the double-door box shields the low voltage part and the high voltage part to minimize electromagnetic interference to prevent faulty communication, incorrect billing information, etc. to improve reliability of the product of the present disclosure.

Furthermore, according to the present disclosure, the front door and the double-door box are installed at the front side of the outer box main body, and the high voltage part constituting the rear charging power supply can be accessed from the front side by opening the front door and the double-door box thereby improving efficiency of maintenance of the electric vehicle charger.

### BRIEF DESCRIPTION OF THE DRAWINGS

FIG. 1 is a perspective view showing an electric vehicle charger with a double-door box separating high and low voltage parts from each other according to the present disclosure.

FIG. 2 is a perspective view showing an opened state of a front door of the electric vehicle charger with a double-door box separating high and low voltage parts from each other according to the present disclosure.

FIG. 3 is a perspective view showing an opened state of both of the front door and a double-door box of the electric vehicle charger with a double-door box separating high and low voltage parts from each other according to the present disclosure.

FIG. 4 is a sectional view showing a closed state of the front door of the electric vehicle charger with a double-door box separating high and low voltage parts from each other according to the present disclosure.

FIG. 5 is a sectional view showing an opened state of the front door of the electric vehicle charger with a double-door box separating high and low voltage parts from each other according to the present disclosure.

FIG. 6 is a sectional view showing an opened state of both of the front door and the double-door box of the electric vehicle charger with a double-door box separating high and low voltage parts from each other according to the present disclosure.

### DETAILED DESCRIPTION OF THE DISCLOSURE

The present disclosure may be variously modified and may have various exemplary embodiments, so examples of which are illustrated in the accompanying drawings and will be described in detail with reference to the accompanying drawings. However, it should be understood that the present disclosure is not limited to specific embodiments, but various modifications, equivalents, additions and substitutions included in the scope and spirit of the prevent disclosure are included in the present disclosure.

In the accompanying drawings, the embodiments of the present disclosure may not be limited to shown specific shapes and may be exaggeratedly drawn to clearly comprehend the present disclosure. It should be understood that the specific terminology used herein is for the purpose of describing the present disclosure and is not intended to limit the meaning of elements or to limit the scope and spirit of the present disclosure described in the claims.

In this specification, terms “and/or” are interpreted to include at least one of components enumerated back and forth. Furthermore, terms “connected/coupled” are interpreted to include being directly connected to another component or indirectly connected to another component through other component. As used herein, the singular forms “a”, “an” and “the” are intended to include the plural forms as well, unless the context clearly indicates otherwise. Furthermore, elements, steps, and operations referred to as “include” or “including” mean the presence or addition of one or more other elements, steps, and operations.

Furthermore, terms such as “a first term and a second term” may be used for explaining various constitutive elements, but the order or other features between the constitutive elements should not be limited to these terms.

In the description of the embodiments, descriptions that each layer (film), region, pattern, or structure is formed “on” or “under” a substrate, each side (film), region, pad, or patterns includes both “is directly formed” and “formed with another layer interposed therebetween”. The criteria for “on/above” or “under/below” of each layer will be described with reference to the accompanying drawings. It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinbelow, an exemplary embodiment of the present disclosure will be described in detail with reference to accompanying drawings.

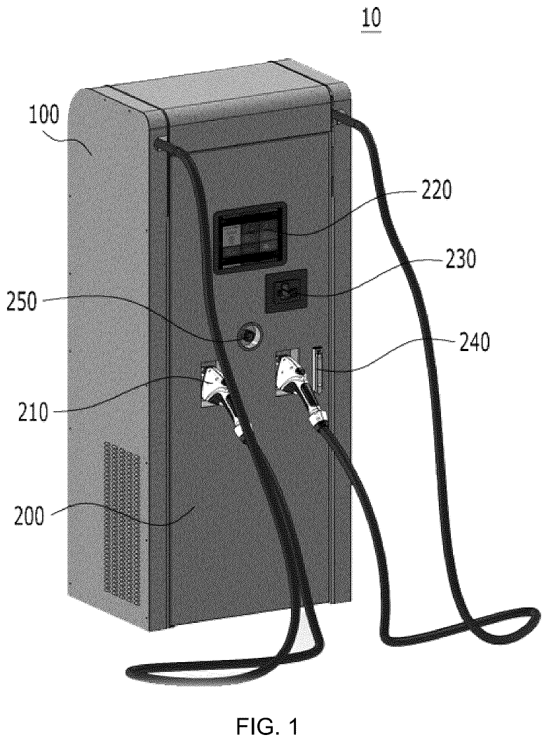

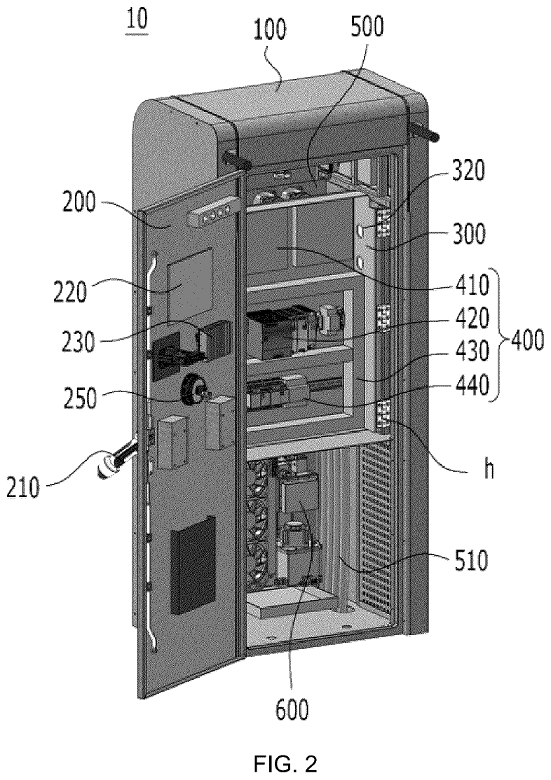

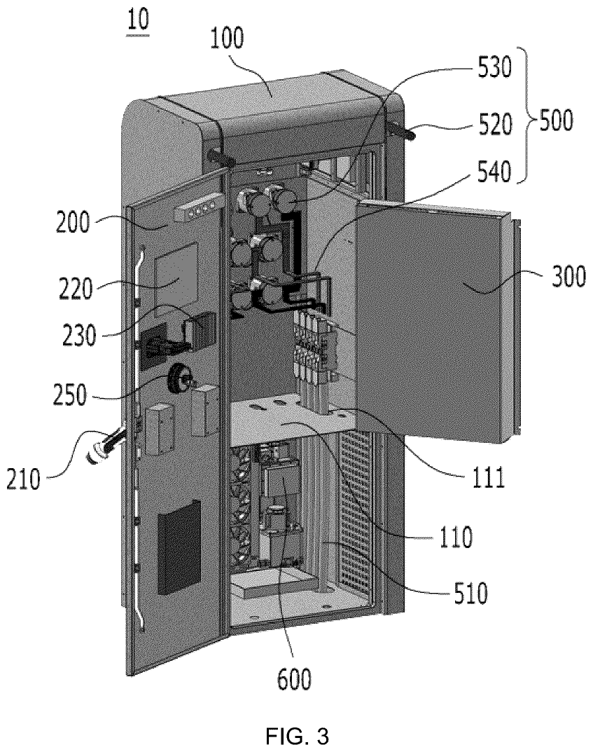

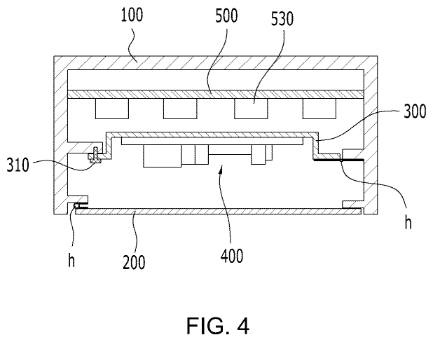

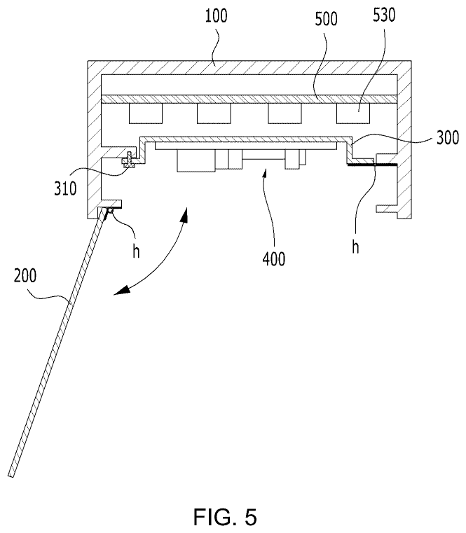

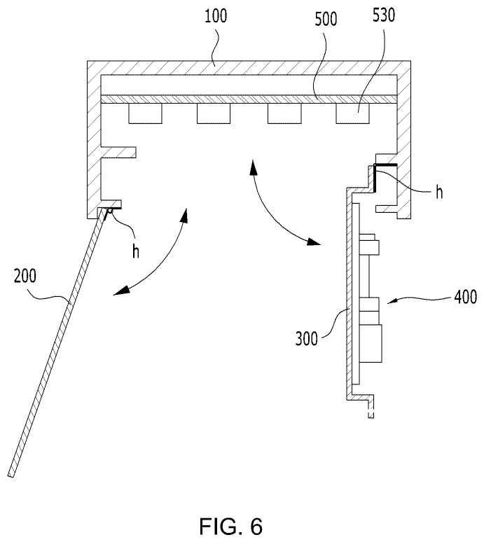

FIG. 1 is a perspective view showing an electric vehicle charger with a double-door box separating high and low voltage parts from each other according to the present disclosure. FIG. 2 is a perspective view showing an opened state of a front door of the electric vehicle charger with a double-door box separating high and low voltage parts from each other according to the present disclosure. FIG. 3 is a perspective view showing an opened state of both of the front door and a double-door box of the electric vehicle charger with a double-door box separating high and low voltage parts from each other according to the present disclosure. FIG. 4 is a sectional view showing a closed state of the front door of the electric vehicle charger with a double-door box separating high and low voltage parts from each other according to the present disclosure. FIG. 5 is a sectional view showing an opened state of the front door of the electric vehicle charger with a double-door box separating high and low voltage parts from each other according to the present disclosure. FIG. 6 is a sectional view showing an opened state of both of the front door and the double-door box of the electric vehicle charger with a double-door box separating high and low voltage parts from each other according to the present disclosure.

As shown in FIGS. 1 to 6, according to the present disclosure, an electric vehicle charger 10 with a double-door box separating high and low voltage parts from each other may include an outer box main body 100, a front door 200, a double-door box 300 in which a low voltage part 400 is installed, and a high voltage part 500.

The outer box main body 100 may have a metal or plastic closure structure with an open front surface, in which components and circuits in the charge are arranged.

The outer box main body 100 may include a cooling part partitioning plate 110 therein, and the cooling part partitioning plate 110 may separate the high voltage part 500 at an upper portion of the outer box main body 100 and a cooling part 600 at a lower portion thereof from each other and block a flow of heat.

The cooling part partitioning plate 110 may be horizontally arranged in the outer box main body 100 and may have an inlet port 111 to allow a DC input cable 510 to be inserted into the cooling part 600.

The front door 200 may be mounted to the front side of the outer box main body 100. At this point, the front door 200 may be mounted to the outer box main body 100 by a hinge h to be enabled to be opened and closed.

The front door 200 may include a connector assembly 210 connected to a DC output cable 520 including an electric line and a communication line and a button controller 220 electrically connected to a control circuit. Furthermore, the front door 200 may include a reader 230 recognizing credit card information, a payment bar code, or a QR code to pay charges.

In addition, the front door 200 may include an opening and closing handle 240 opening and closing the front door 200 to open and close the internal space of the outer box main body 100 and an emergency stop switch 250 stopping an operation of the electric vehicle charger 10 when an emergency event occurs during charging.

The double-door box 300 may be mounted to one portion of the front side of the outer box main body 100. In other words, as the double-door box 300 is installed to the outer box main body 100, the low voltage part 400 installed on the front side of the double-door box 300 and the high voltage part 500 installed in the outer box main body 100 are shielded by the double-door box 300 so that electromagnetic interference can be prevented.

At this point, the double-door box 300 may be connected to the outer box main body 100 by the hinge h and may be rotated on the hinge h.

Furthermore, a fixing member 310 may be provided on a second portion of the double-door box 300 to fix the double-door box 300 to the outer box main body 100.

Meanwhile, the front door 200 may be mounted to the left portion of the front side of the outer box main body 100 and the double-door box 300 is mounted to the right portion of the front side of the outer box main body 100, so that the front door 200 and the double-door box 300 may be opened and closed alternately. In other words, the front door 200 may be opened and closed in a leftward direction from the front surface of the outer box main body 100 and the double-door box 300 may be opened and closed in a rightward direction from the front surface of the outer box main body 100. Accordingly, the double-door box 300 is opened while the front door 200 is opened.

A cable inlet port 320 may be formed on an inner surface of the double-door box 300 to allow the cable to be inserted so that the cable may be connected to the low voltage part 400.

The double-door box 300 may be made of an electromagnetic wave shield material to prevent electromagnetic interference of the low voltage part 400 and the high voltage part 500. The electromagnetic shield material may be at least one of shield fibers formed by adding copper ions to copper, aluminum, or acrylic fiber.

The low voltage part 400 may be installed at the front side of the double-door box 300. Accordingly, the low voltage part 400 may be separated from the high voltage part 500 by the double-door box 300. The low voltage part 400 serves to take charge of control/communication, and may include a charger controller 410, a DC power supply device 420, a low voltage cable duct 430, a relay 440, etc.

The high voltage part 500 may be installed at an inner rear surface of the outer box main body 100, and in other words, may be installed behind the double-door box 300. Accordingly, the high voltage part 500 may be disposed to be separated from the low voltage part 400 by the double-door box 300.

The high voltage part 500 may serve to supply power for charging, and may include the DC input cable 510, the DC output cable 520, a high voltage relay 530, a high voltage bus bar 540, etc.

The electric vehicle charger 10 with a double-door box separating high and low voltage parts from each other of the present disclosure having the above-described configuration may be configured to pay charges for charging by using a button controller 220 disposed on the front door 200 and the reader 230 and then to perform charging by using a connector assembly 210.

The double-door box 300 with the low voltage part 400 at the front surface thereof may be mounted to the outer box main body 100 inside the front door 200 to be rotatable by the hinge h. Therefore, the low voltage part 400 and the high voltage part 500 installed inside the outer box main body 100 may be shielded from each other by the double-door box 300 and electromagnetic interference can be prevented.

Furthermore, when the front door 200 mounted to the front side of the outer box main body 100 is opened, the low voltage part 400 provided on the front surface of the double-door box 300 and provided for control/communication can be easily accessible from the front side of the outer box main body 100 so that maintenance of the low voltage part 400 can be easily performed.

Furthermore, when the double-door box 300 is opened on the hinge h, the high voltage part 500 installed on the internal surface of the outer box main body 100, the high voltage part 500 supplying power for charging, can be easily accessible from the front side of the outer box main body 100 so that the maintenance of the high voltage part 500 can be easily performed.

Therefore, according to the present disclosure, the double-door box 300 with the low voltage part 400 installed on the front surface thereof may be provided inside the front door 200 and the high voltage part 500 may be provided behind the double-door box 300.

Accordingly, the low voltage part 400 and the high voltage part 500 are separated from each other by the double-door box 300 and a variety of electromagnetic interference such as faulty communication, incorrect billing information, etc.

In addition, the front door 200 may be mounted to be openable and closable at the left portion of the front side of the outer box main body 100 and the double-door box 300 may be mounted to be openable and closable at the right portion of the front side of the outer box main body 100, and therefore the front door 200 may be opened and closed in a leftward direction at the front side of the outer box main body 100 and the double-door box 300 may be opened and closed in a right direction at the front side of the outer box main body 100. Accordingly, the low voltage part 400 and the high voltage part 500 and all parts of the outer box main body 100 can be easily accessible towards the internal space so that efficiency of maintenance can be improved.

In the description of the present disclosure above, the specific embodiment of the present disclosure has been disclosed for illustrative purposes. However, it is thus well known to those skilled in that art that the present disclosure is not limited to the embodiment disclosed in the detailed description, and it should be understood that the present disclosure includes various modifications, additions, and substitutions within the scope and spirit of the present disclosure defined by the accompanying claims.

Therefore, the present disclosure is not limited to the specific embodiment and description as described above, and ordinary skill in the art to which the present disclosure belongs will appreciate that various modifications, additions and substitutions are possible, without departing from the scope and spirit of the present disclosure as disclosed in the accompanying claims, and the modifications exist in the patent right of the present disclosure.

What is claimed is:

1. An electric vehicle charger comprising:
an outer box main body;
a front door mounted to a front portion of the outer box main body and configured to be opened and closed;
a double-door box mounted to an inner side portion of the outer box main body and configured to be opened and closed and comprising a low voltage part that is arranged thereon; and
a high voltage part separated from the low voltage part by the double-door box.

2. The electric vehicle charger of claim 1, wherein the high voltage part is arranged on a surface mounted to an inner side portion of the outer box main body.

3. The electric vehicle charger of claim 1, wherein the outer box main body has a closure structure of which the front door is configured to be opened or closed and comprises a cooling part partitioning plate separating the high voltage part at an upper portion and a cooling part at a lower portion from each other and blocking a flow of heat.

4. The electric vehicle charger of claim 3, wherein the cooling part partitioning plate comprises an inlet port that allows a cable to be inserted into the cooling part.

5. The electric vehicle charger of claim 3, wherein the cooling part partitioning plate is horizontally arranged in the outer box main body.

6. The electric vehicle charger of claim 1, wherein the front door is hinged to the front portion of the outer box main body.

7. The electric vehicle charger of claim 1, wherein the front door comprises a connector assembly connected to a cable that includes an electric line and a communication line.

8. The electric vehicle charger of claim 1, wherein the front door comprises a button controller electrically connected to a control circuit.

9. The electric vehicle charger of claim 1, wherein the front door comprises a reader recognizing credit card information, a payment bar code, or a QR code to pay charges.

10. The electric vehicle charger of claim 1, wherein the front door comprises an opening and closing handle that is configured to open and close the front door.

11. The electric vehicle charger of claim 1, wherein the front door comprises an emergency stop switch to stop operation of the electric vehicle charger when an emergency event occurs during charging.

12. The electric vehicle charger of claim 1, wherein the front door and the double-door box are respectively mounted to opposite inner side portions the outer box main body so that the front door and the double-door box are configured to be opened and closed alternately.

13. The electric vehicle charger of claim 1, wherein the double-door box comprises the low voltage part provided at a front surface thereof, the low voltage part taking charge of control/communication of the electric vehicle charger, and a first portion of the double-door box is connected to the outer box main body by a hinge.

14. The electric vehicle charger of claim 9, wherein the double-door box comprises a fixing member at a second portion, to which the hinge is connected, to allow the double-door box to be fixed to the outer box main body.

15. The electric vehicle charger of claim 1, wherein the double-door box comprises a cable inlet port to allow a cable to be inserted.

16. The electric vehicle charger of claim 1, wherein the double-door box is made of an electromagnetic shield material to prevent electromagnetic interference of the low voltage part and the high voltage part.

17. The electric vehicle charger of claim 16, wherein the electromagnetic shield material is made by adding copper ions to copper, aluminum, or acrylic fiber.

18. The electric vehicle charger of claim 1, wherein the low voltage part comprises a charger controller, a DC power supply device, a low voltage cable duct, and/or a low voltage relay.

19. The electric vehicle charger of claim 1, wherein the high voltage part serves to supply power for charging.

20. The electric vehicle charger of claim 1, wherein the high voltage part comprises a DC input cable, a DC output cable, a high voltage relay, and/or a high voltage bus bar.
